(19) United States
(12) Patent Application Publication
(10) Pub. No.: US 2023/0232862 A1
(43) Pub. Date: Jul. 27, 2023

(54) METHOD FOR PRODUCING LARVAE REARING SUBSTRATE

(71) Applicant: Innovafeed, Nesle (FR)

(72) Inventors: Clément Ray, Paris (FR); Nicolas Hamelin, Paris (FR); Alexandre Lauro, Paris (FR)

(21) Appl. No.: 17/999,482

(22) PCT Filed: May 21, 2021
(86) PCT No.: PCT/FR2021/050938

§ 371 Date: Nov. 21, 2022

(30) Foreign Application Priority Data
May 21, 2020 (FR) FR2005409

(51) Int. Cl. A23K 10/37; A23K 50/90; A23K 20/147; A23K 20/158; A23K 20/163; A23K 50/60

(52) U.S. Cl. CPC A23K 10/37; A23K 50/90; A23K 20/147; A23K 20/158; A23K 20/163; A23K 50/60

(57) ABSTRACT

The present disclosure relates to the field of insect rearing. More particularly, the present disclosure relates to an insect larvae rearing substrate prepared from solubles derived from plant processing methods, in particular for the production of starch, proteins, ethanol or palm oil, a preparation method therefor and a rearing method using such a substrate.

### CROSS-REFERENCE TO RELATED APPLICATIONS

This application is a national phase entry under 35 U.S.C. § 371 of International Patent Application PCT/FR2021/050938, filed May 21, 2021, designating the United States of America and published as International Patent Publication WO 2021/234329 A1 on Nov. 25, 2021, which claims the benefit under Article 8 of the Patent Cooperation Treaty to French Patent Application Serial No. FR2005409, filed May 21, 2020.

### TECHNICAL FIELD

The present disclosure relates to the field of insect rearing. It relates more particularly to an insect larvae rearing substrate prepared from solubles derived from plant processing methods, in particular for the production of starch, proteins, ethanol or palm oil, a preparation method therefor and a rearing method using such a substrate.

### BACKGROUND

Protein production is one of the key issues of the coming decades, with a growing deficit in the world (60 Mt by 2030). With 70% of the proteins consumed in agriculture currently imported, mainly in the form of soybean meal, Europe and European companies must develop solutions to reduce this dependence.

The protein deficit is particularly critical for the aquaculture sector. With nearly half of wild fish stocks exploited at biologically unsustainable levels, aquaculture is expanding rapidly to meet growing global demand. According to the 2016 FAO report on the state of world fisheries and aquaculture, the majority of aquatic products today come from aquaculture and no longer from fishing. With growth of more than 5% per year, the aquaculture sector is the fastest growing agribusiness sector.

Insect rearing responds to this problem by providing a source of nutrients for animal nutrition and agriculture. These products make it possible to introduce new, more sustainable protein sources, particularly in aquaculture, for which insect proteins are particularly suitable.

Indeed, insect meal is emerging as an excellent solution to support the growth of fish farming, whose traditional sources of food (wild fish meal or soy meal) are insufficient and have a strong environmental impact.

Furthermore, the starch, ethanol, protein and palm oil industries generate plant co-products that can be used as sources of proteins, lipids and carbohydrates. These co-products can be used to manufacture insect larvae rearing media.

Industries transforming plants into by-products include industries producing starch (generally from cereals, in particular wheat or corn, but also potatoes), bio-alcohol (bioethanol, generally from corn, but also possibly other cereals), protein (from protein crops, such as peas) and oil (from in particular palm oil from the fruit of the oil palm and palm kernel oil from oil palm fruit kernels).

In general, industrial processes are processes in which the desired compounds are isolated by mechanical methods (grinding, separation of different fractions for starch production or the preparation of proteins), which may also include fermentation and distillation (production of bioethanol) steps. These processes use large amounts of water, especially in the separation steps, and lead to co-products, called solubles, which are essentially aqueous compositions containing compounds derived from plants (lipids, proteins, sugars, etc.) soluble in the aqueous phase, and which are co-products of the main process.

These solubles can be supplemented by other co-products of these industrial processes and today are generally dried, which concentrates the components, and the resulting compositions, in the form of pellets (moisture content generally less than 15%), are used in particular in animal nutrition. However, this drying step, necessary to obtain compositions that are acceptable for transport and suitable for the needs of livestock farms, requires large amounts of energy.

### BRIEF SUMMARY

It has been discovered that these solubles could be used to manufacture insect larvae rearing media.

Thus, the present disclosure relates to an insect larvae rearing substrate in lumpy form and with a semi-liquid or pasty texture comprising:

solubles from plant processing methods, and

plant co-products in solid form.

The present disclosure also relates to a method for preparing an insect larvae rearing substrate as well as an insect larvae rearing method using a substrate as described herein.

The larvae rearing substrate of the present disclosure may have several advantages.

In particular, it allows the larvae to live, move and feed in a single medium, without the need to change this medium or provide other sources of nutrients to the larvae. This rearing substrate, with its characteristics of a lumpy, semi-liquid or pasty (“porridge” style) and homogeneous texture, allows the larvae to have access to nutrients and to drink throughout the rearing period without risk of drowning. At the end of rearing, the substrate is dry, which allows the larvae to be separated and recovered without difficulty.

The substrate and the preparation method thereof described in the present disclosure are particularly interesting in that they use the solubles “as is” upon exiting the industrial plant processing methods, and in that the addition of solid components, themselves from the agro-processing sector, makes it possible to modify the texture and the nutritional composition and thus to obtain rearing media that can be used for the larvae. It can also be noted that these media have a much higher moisture content than the other foods offered for rearing larvae obtained from solubles (possibly supplemented), which are generally in the form of pellets.

Another advantage of using solubles “as is” lies in doing away with the need to dry these solubles (a process currently used by processing industries), which saves energy and money compared to the current uses of these solubles.

In general, the solubles that can be used in the context of the present disclosure can be obtained by any treatment/method for processing plant products or co-products that allows the nutrients they contain to be extracted and/or solubilized.

The substrate, preparation method and rearing method described below are preferably implemented in facilities that are geographically close to plant processing facilities. Indeed, this makes it possible to avoid transporting large volumes of solubles. Thus, preferably, these methods and uses are implemented from the solubles coming from pipes directly connected in the plant processing plants, and bringing the solubles to the facilities in which they are mixed with the supplements to give the insect larvae rearing media. Preferably, the processing of plants (for example, to produce starch, bioethanol, proteins) and the processes and methods described here are implemented “continuously,” that is to say, the solubles are not stored for more than 24 hours between their production as a co-product of plant processing methods and their use in rearing substrate preparation methods. This also makes it possible to reduce the storage costs of these solubles. In the case where palm oil co-products are used, which can be kept longer before use, storage is possible, offering more flexibility in the industrial chain.

The present disclosure therefore makes it possible to solve the problems of:

energy consumption (linked to the drying of solubles),

storage (particularly when the plant processing and rearing medium manufacturing units are geographically close (separated by less than 50 km generally, or even less than 20 km, preferably 10 km or less) and when solubles are used quickly (a few hours) after obtaining),

recovery of these solubles (indirect recovery via the valorization of the by-products obtained from the reared larvae and insects), and

treatment of effluents and/or pollution (in the case of palm oil effluents).

It is appreciable that the plant processing units and rearing substrate manufacturing units are sufficiently close so that the solubles can be sent from the former to the latter by means of hoses or pipes.

### BRIEF DESCRIPTION OF THE DRAWINGS

FIG. 1 is an image of a composition having a conforming structure, the composition being homogeneous and lumpy.

FIG. 2 is an image of a composition having a non-conforming structure, with arrows showing pockets of visible or free water.

FIG. 3 is a schematic illustration of the industrial processing method for oil palm fruits.

### DETAILED DESCRIPTION

A first object of the present disclosure relates to an insect larvae rearing substrate in lumpy form and with a semi-liquid or pasty texture comprising:

solubles from plant processing methods, and

plant co-products in solid form.

Thus, the present disclosure relates to the use of solubles derived from plant processing methods, for the preparation of a composition intended for rearing insect larvae. This “substrate,” also called “rearing medium,” is a composition intended for rearing insect larvae; it is nutritious and serves as a physical support for the larvae due to its particular mechanical properties (described below).

In a preferred embodiment of the present disclosure, the solubles are derived from plant processing methods for the production of starch, proteins, ethanol or palm oil.

The following industrial processes can be described in particular, producing solubles that can be used in the context of the present disclosure:

Production of ethanol from wheat (or another small grain): ethanol production is carried out from soluble fractions recovered during starch extraction, which are fermented and then distilled. Distillation solubles (which are not alcohol), also called “vinasses,” are perfectly suited to the implementation of the present disclosure. These solubles have a dry matter content of between 8 and 12% for non-evaporated vinasses, and between 12 and 35% for evaporated vinasses.

Solubles from the starch industry without distillation (wheat or other small grains): these are solubles that can be used for distillation (above), preferably concentrated by evaporation (to obtain a dry matter content of 12-25%). These solubles are obtained after mixing flour with water to form a paste allowing the separation of starch and gluten by washing. The usable solubles are the nutrient-laden waters resulting from this separation process.

Production of ethanol from corn: the corn (cleaned) is placed in soaking (or steeping) water, which causes the grains to swell and allows the soluble components to be separated. This steeping water is then fermented and distilled. The solubles that can be used in the present disclosure are the distillation residues (which are not alcohol). They generally have a dry matter content of between 20% and 50%. This steeping water may be used directly, or possibly concentrated.

Production of proteins from protein crops (peas): these processes first include extracting the starch and part of the proteins, then extracting the protein extracts by coagulation of protein juice. The solubles that can be used are the post-coagulation liquid fraction, preferably concentrated by evaporation to 20-32% dry matter.

Production of oils from oleaginous plants: these processes give co-products that are in the form of aqueous solutions containing nutrients, in particular proteins, lipids and/or carbohydrates. Co-products from oleaginous plants of interest are those from the palm oil industry. These are co-products and effluents from palm oil (crude palm oil) and/or palm kernel oil production processes and/or from palm oil or palm kernel oil refinery. More specifically, the solubles from the palm oil industry that can be used in the present disclosure are palm oil mill effluents (POME). POMEs can group together part or all of the water from the palm oil sterilization, extraction and clarification process. These are very fluid or pasty liquids (1 to 40% dry matter) loaded with organic matter, fibers and residual oils. POMEs also include palm oil mill sludge containing 1 to 25% dry matter, decanter cake containing 10 to 40% dry matter.

Thus, the solubles as used in the context of the present disclosure are highly variable, both in their origin and in their composition (dry matter or nutrient content). However, they all present sources of soluble proteins and potentially of carbohydrate components that are now used in methanization, in biomass for energy production or as pellets for animal feed after drying, which is energy-intensive.

These soluble products can be mixed with other plant co-products in solid form, in order to obtain a rearing substrate having both a nutritional composition and a texture suitable for insect larvae growth. These plant co-products in solid form can be chosen from wheat bran, compacted or not, corn fibers, compacted or not, centrifugation cakes and solid co-products from the palm oil industry.

Indeed, the palm oil industry produces solid plant co-products that can be mixed with solubles to provide the desired texture to the rearing substrate. They include:

the empty oil palm bunch (empty fruit bunch, EFB) after sterilization of the fresh bunch,

oil palm fibers, which are the fibrous residue from the separation of the palm oil (or crude palm oil) from the sterilized fruit (palm fiber), and

palm kernel cakes (PKC), which contain 80 to 98% dry matter; these include the palm kernel expeller (PKE) and palm kernel meal (PKM). These are the co-products of palm kernel oil extraction obtained by a mechanical or solvent extraction process.

In a particular embodiment of the present disclosure, the substrate is obtained by mixing co-products from the palm oil industry, namely (i) solubles obtained from palm oil mill effluents (POME), effluents from the palm oil and/or oil palm fruit kernel oil refining process, and (ii) solids selected from unfermented palm kernel cakes (PKC), and fermented palm kernel cakes, oil palm fibers and empty oil palm bunches.

The rearing substrate is characterized by a specific and evolving texture making it possible to guarantee optimal rearing conditions throughout the growth of the larvae, from a zootechnical, energy and economic point of view.

At the start of rearing, the texture is lumpy, semi-liquid or pasty: it guarantees first access to nutrients and the mobility of the larvae, allowing them to colonize the environment naturally without outside intervention. The high moisture content of the substrate allows the larvae to drink, while its lumpy texture forms a support that prevents the larvae from drowning. Indeed, the presence in the mixture of an initial dry fraction (e.g., wheat bran, corn fibers or the like) makes it possible to retain water while avoiding the presence of visible water, which evaporates quickly and can thus cause early drying, and therefore the loss of opportunity for the larva to ingest nutrients. The presence of visible water would also be detrimental to the survival of the larva, which would have difficulty moving and breathing in an aqueous medium;

During rearing, the texture gradually evolves toward a drier state while maintaining a homogeneous moisture level, without the presence of visible water: it guarantees that all the larvae have access to the same substrate and the same nutrients throughout the consumption phase, while drinking naturally, without additional devices or additives and without outside intervention;

At the end of rearing, the texture resembles a dry granular medium made up of digested co-products: it guarantees optimal mechanical separation between the larvae and the residues, which will then be processed and recycled separately.

This optimized texture of the rearing substrate is thus obtained by adjusting the initial moisture content between 65% and 80%, owing to combinations of co-products listed above, and if necessary, adding water. The nutrients present in the solubles (soluble proteins, polypeptides and carbohydrates) make it possible to accelerate and improve the growth of insect larvae.

In general, the compositions used as an insect larvae rearing substrate are in a lumpy form (of semi-liquid or pasty texture) and comprise between 20% and 35% dry matter, between 8% and 30% proteins (on dry matter), and between 1% and 16% lipids (on dry matter) and/or between 0% and 70% carbohydrates (on dry matter).

Particular compositions according to the present disclosure, obtained from solubles resulting from plant processing methods for the production of starch, proteins, ethanol, can be characterized by the following data:

Dry matter content: between 20% and 35%;

Protein content: between 12% and 30% on dry matter;

Carbohydrate content: between 12% and 30% on dry matter, and/or;

Lipid content: between 3% and 6% on dry matter, and/or;

Ash content: between 2% and 10% on dry matter.

Other particular compositions according to the present disclosure, obtained from solubles resulting from palm oil processing methods, can be characterized by the following data:

Dry matter content: between 20% and 35%;

Protein content: between 10% and 25% on dry matter;

Carbohydrate content: between 0% and 70% on dry matter;

Lipid content: between 1% and 16% on dry matter.

These compositions are perfectly suited to rearing insect larvae. In particular, mention may be made of Diptera Hermetia illucens, Musca Domestica, beetles Tenebrio molitor, Alphitobius diaperinus as well as locusts Acheta domesticus, Gryllodes sigillatus or Field Cricket Gryllus assimilis, and preferably, particularly suitable for rearing larvae of Hermetia illucens.

A second object of the present disclosure relates to a preparation method for an insect larvae rearing substrate in lumpy form and with a semi-liquid or pasty texture comprising the mixture of (i) solubles derived from plant processing methods, and (ii) plant co-products in solid form.

In particular, it has been shown that the solubles can be mixed with solid plant co-products such as wheat bran, compacted or not, with corn fibers, compacted or not (also called fine corn gluten feed or coarse corn gluten feed), centrifuge cake (also called wet cake) and palm kernel cakes (also called PKC, PKM, PKE). By adding solubles to these supplements with constant stirring, the mixture makes it possible to obtain a composition in lumpy form, a mixture of liquid and granular fraction, with a semi-liquid or pasty texture (but having a few lumps, corresponding to the supplements added to the solubles).

The present disclosure thus relates to the use of solubles derived from plant processing methods, in particular for the production of starch, proteins, ethanol or palm oil, in particular as described above, and in the examples, for the preparation of a composition intended for rearing insect larvae.

As seen above, the solubles are supplemented with compounds allowing the desired texture to be obtained, and so that the composition of the substrate comprises between 20% and 35% dry matter, between 8 and 30% proteins (on dry matter), between 1 and 16% lipids (on dry matter) and/or between 0% and 70% carbohydrates (on dry matter), preferably between 12 to 30% carbohydrates. In a particular embodiment, the substrate comprises between 15% and 30% proteins, and preferentially between 3% and 6% lipids and/or between 12% and 30% carbohydrates.

The solid co-products, sources of proteins, lipids and/or carbohydrates, added to the solubles as supplements are preferably chosen from wheat products, in particular wheat bran, compacted or not, corn fibers, compacted or not, centrifugation cakes and palm kernel cakes.

Wheat by-products are co-products of the primary wheat processing industry (milling, semolina production, starch production) and are obtained during the manufacture of flour and semolina. The by-products are mainly made up of fragments of the husk of wheat grains and grain particles from which the albumen has been removed. Wheat by-products are mainly brans, middlings, second clear flours and germs and represent on average 25 to 30% of the wheat grain. Wheat by-products contain protein, and other constituents.

TABLE 1
Constituents of certain wheat by-products

| Constituents | Bran | Middling | Germ |
|---|---|---|---|
| Moisture | 13.1 | 12.0 | 10.5 |
| Proteins | 15.3 | 15.7 | 30.0 |
| Plant walls (“Fibers”) | 39 | 30.2 | 14.5 |
| Starch | 19.3 | 28.5 | 20.3 |
| Lipids | 2.6 | 3.1 | 10 |
| Mineral salts | 4.9 | 4.1 | 4.0 |

In a preferred embodiment, the composition is prepared continuously from the solubles. It is intended to indicate that the composition is prepared from solubles sent directly by pipes or hoses to the preparation facilities, without there being any road transport between the plant processing facilities and the rearing substrate preparation facilities. In another embodiment, the solubles are transported to the substrate preparation facilities, which are located a short distance (less than 50 km, but preferably 20 km or less) from the plant processing facilities. Too great a distance increases transport costs and reduces the profitability of the methods. The solubles can be stored in the rearing substrate preparation facilities, but this storage is generally short, as seen above, even if this is less true in the case of storage-stable co-products.

After the solubles are received in the rearing substrate preparation facilities, they are analyzed. In particular, their dry matter content, their protein, lipid, carbohydrate, fiber content, etc., are determined. Depending on the composition of the soluble, it is possible to determine the amount of supplement (particularly wheat bran) that must be mixed to obtain the desired texture and composition for the rearing substrate. These elements are easily determined by a person skilled in the art who has the appropriate tools to carry out the composition measurements in the solubles and the added supplements.

The present disclosure thus relates to a process (or a method) for manufacturing an insect larvae rearing substrate from solubles derived from plant co-products, in particular derived from the production of starch, ethanol from corn or wheat or palm oil, comprising the mixture of these solubles with sources of proteins, lipids and/or carbohydrates (solid plant co-product) in order to obtain a composition comprising between 20% and 35% dry matter, between 8% and 30% protein (on dry matter), and preferably between 3% and 16% lipids (on dry matter) and/or between 0% and 30% carbohydrates (on dry matter).

In a particular preparation method, wheat bran, whether compacted or not, is added to the solubles, possibly with other supplements. Wheat bran makes it possible in particular to obtain the nutritional supplements to obtain the desired content level in the substrate, to reduce the moisture, and to obtain the desired semi-liquid lumpy texture.

The rearing substrate is in particular prepared by gradually adding liquid solubles to wheat products, in particular compacted or uncompacted wheat bran, and/or compacted or uncompacted corn fibers, and/or centrifugation cake and/or palm oil industry by-products, and in particular palm kernel oil cakes, maintaining continuous mixing during this incorporation. This mixing can be carried out in a blender or a solid/liquid mixer. In order to obtain a homogeneous substrate, it is preferable to add the solubles gradually, mixing continuously to incorporate the solid extracts (from wheat, corn fibers, centrifugation cakes, palm kernel cakes, etc.) into the soluble, and to avoid the formation of bunches that would contain non-hydrated solids and leave pockets of free water.

A third object of the present disclosure relates to a method for rearing insect larvae including:

depositing the larvae at the young larvae stage on a substrate as defined above;

incubating the larvae for 1 to 60 days, at a temperature between 25 and 45° C.; and

recovering the larvae by separating them from the residues and droppings.

In a preferred embodiment, this method does not require renewing the substrate during the rearing cycle. The substrate is laid out at the start of rearing and provides all of the useful nutrients throughout the larva's growth period, in sufficient quality and quantity.

The present disclosure also relates to the use of a rearing medium as manufactured and described above for rearing insect larvae, as well as to a method for rearing insect larvae, comprising incubating insect larvae on such a substrate, under suitable temperature and humidity conditions, and optionally recovering the larvae after 1 to 60 days of incubation. One benefit of the substrate and its use is that it is not necessary to change it or renew it frequently (it can be used for more than ten days), and that a complete rearing cycle can therefore be carried out on a single batch of substrate. In a particular embodiment of the present disclosure, it is specified that the substrate does not contain any gelling agent.

Generally, the larvae are placed on the rearing substrate at the young larvae stage, then grow at a temperature between 25 and 45° C., at a moisture content between 30 and 90%, for a period of between 1 and 60 days, depending on the insect considered.

Insects can then be collected at the larvae or pupae development stage. The larvae can be used to produce high-protein foods (in particular intended for aquaculture), oils or organic fertilizers; the pupae can be used to produce reproductive adults to generate new generations of insects.

### EXAMPLES

### Example 1. Production of Solubles from Wheat Distillation

Raw material: Wheat

Method
In a starch production plant, gluten is separated from starch milk, which is heated by injecting steam and then transformed into glucose by enzymatic means. Part of this weakly concentrated starch milk is taken to a fermentation workshop.
i) Fermentation: a fraction of the starch milk is taken to the fermentation workshop, where it is then treated with yeasts whose fermentation makes it possible to obtain an alcoholic liquid at 10°;
ii) Distillation: This alcoholic liquid is then distilled in a distillation workshop to produce alcohol at 92% vol. The residues from this step constitute the soluble that can be used to prepare the insect rearing substrate. It is a soluble of between 8 and 12% dry matter, commonly called vinasse, containing residual soluble proteins and polypeptides of interest in particular for the nutrition of Hermetia illucens. These solubles can be used directly or undergo one, the other or both of the following transformations;
iii) Centrifugation: making it possible to separate two phases of the vinasses. One of these phases is rich in protein and the other is poorer. The phase poor in protein retains the desired properties for the nutrition of Hermetia illucens; and
iv) Evaporation: aims to concentrate the vinasses by bringing them to a higher dry matter content of 12-35% dry matter.

The solubles derived from this process therefore have a composition:
Dry matter content: between 8 and 12% for non-evaporated vinasses, and between 12 and 35% for evaporated vinasses;
Protein content: between 20% and 28% on dry matter;
Carbohydrate content: between 2% and 6% on dry matter;
Lipid content: between 2% and 6% on dry matter; and
Ash content: between 6% and 10% on dry matter.

Supplements
The addition of wheat bran, compacted or not, or centrifugation cake (wet cake), allows the dry matter to be increased and the texture and the composition necessary for larvae rearing to be obtained.

These solubles are known in the art and generally referred to as “vinasses,” “stillage,” “heavy stillage,” “whole stillage” or “thin stillage.”

### Example 2. Production of Solubles from Wheat Processing

Raw material: Wheat

Method

The starch milk fraction likely to be sent to a fermentation workshop is used. This starch milk fraction, which therefore contains residual sugars and is in liquid form containing between 8 and 12% dry matter, commonly called “wheat soluble” or “wheat liquid feed.” These solubles can be used directly or undergo a concentration step by evaporation, in order to concentrate the solubles by bringing them to a higher dry matter content of 12-25% dry matter.

Composition
Dry matter content: between 8 and 12% for non-evaporated solubles, between 12 and 25% for evaporated solubles;
Protein content: between 15% and 21% on dry matter;
Carbohydrate content: between 25% and 70% on dry matter;
Lipid content: between 2% and 6% on dry matter; and
Ash content: between 1% and 5% on dry matter.

Supplements
The addition of wheat bran increases the dry matter and obtains the texture and composition necessary for larvae rearing.

Technical names (non-exhaustive list): “solubles,” “wheat liquid feed.”

### Example 3. Production of Solubles Derived from Distillation from Corn

Raw material: Corn

Method
The steeping waters are sent to a fermentation workshop and are inoculated with yeasts to obtain an alcoholic liquid by fermentation;
Distillation: This alcoholic liquid is then distilled in a distillation workshop to produce alcohol at 92% vol. The residues of this stage, commonly called “stillage,” contain residual soluble proteins and polypeptides of interest for the nutrition of Hermetia illucens; and
These solubles can be used directly or undergo a concentration step by evaporation, in order to concentrate the solubles by bringing them to a higher dry matter content of 20-50% dry matter. After evaporation, these solubles are called “heavy stillage.”

Composition
Dry matter content: between 20% and 50%;
Protein content: between 25% and 40% on dry matter;
Carbohydrate content: between 3% and 6% on dry matter;
Lipid content: between 2% and 6% on dry matter; and
Ash content: between 1% and 5% on dry matter.

Supplements
It is possible to add corn fibers, compacted or not (fine corn gluten feed or coarse corn gluten feed), or centrifuge cake (wet cake) or wheat bran, compacted or not, to obtain the desired composition and texture.

Technical names (non-exhaustive list): “vinasses,” “stillage,” “heavy stillage,” “whole stillage,” “thin stillage.”

### Example 4. Production of Soluble by Protein Extraction from Yellow Peas

Raw material: Yellow peas

Method
Pea cream is made up of two wet co-products obtained during the wet refining of yellow peas after extraction of the starch and part of the proteins: wet pea pulp and concentrated pea solubles;
After starch extraction, the wet pea pulp is obtained by pressing the cake resulting from decanting;
After decanting, pea protein extraction is done by coagulation of the protein juice;
The post-coagulation liquid fraction is then concentrated by evaporation to 28-30% dry matter to obtain pea soluble; and
The pulp is then incorporated into the soluble to obtain a pea cream in the form of a whitish liquid.

Wheat bran is mixed with pea soluble or cream to obtain an insect larvae rearing substrate composition.

### Example 5. Preparation of Rearing Substrates

Solubles were recovered from the methods of Examples 1 to 4.

These solubles were added to wheat bran:

Mixing was done in a continuous flow solid/liquid mixer (device allowing the incorporation of liquids into granular materials) by injecting the solubles into the granular material of the supplements, at a temperature between 20° C. and 70° C. and by continuously monitoring the volumes added and the moisture content.

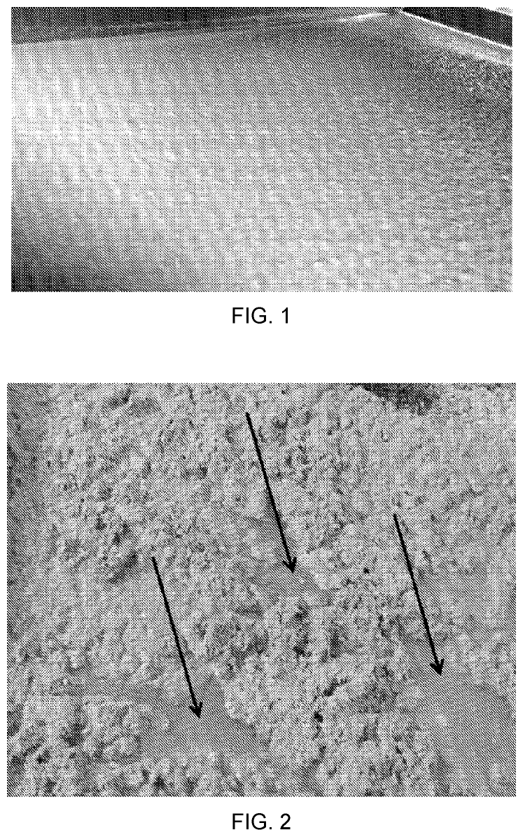

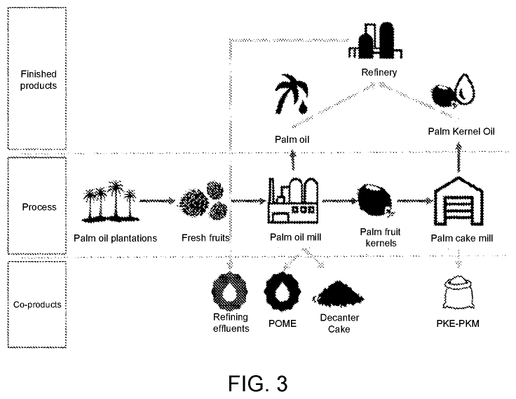

A composition was thus obtained (FIG. 1) having the following characteristics:

Takes the form of a lumpy composition (semi-liquid);

Between 20% and 35% dry matter;

Between 15% and 30% protein (on dry matter);

Between 3% and 6% lipids (on dry matter); and

Between 12% and 30% carbohydrates (on dry matter).

This composition was used as a rearing medium for larvae of Hermetia illucens: 1 kg of young larvae (3 days) was deposited on 50 kg of medium and was placed in a room at 30° C., without light.

The larvae grew and were harvested after 7 days (development stage), then were used in thermo-mechanical processing methods to extract lipids and protein flours.

### Example 6. Preparation of a Rearing Substrate from Palm Oil Co-Products

Raw material: oil palm fruit

Method
Palm oil mill effluent (POME) is used, which can be sent to settling ponds or be centrifuged and/or decanted. These effluents therefore contain organic matter, fibers and residual oils and are in liquid form containing between 1 and 40% dry matter. According to the recovery step in the effluent treatment process, these solubles can be used directly or else undergo a humidification step by adding water, bringing them to a lower dry matter content of 1-15% of dry matter.
These solubles were added to fermented palm kernel cake (PKC) containing 50 to 98% dry matter, or unfermented palm kernel cake containing 80 to 98% dry matter.

Composition
Dry matter content: between 1% and 25%;
Protein content: between 8% and 20% on dry matter;
Carbohydrate content: between 25% and 70% on dry matter; and
Lipid content: between 3% and 16% on dry matter.

Supplements

The addition of palm kernel cake (PKC), fermented or not, increases the dry matter and obtains the desired texture and composition to allow larvae rearing.

1. An insect larvae rearing substrate, comprising:
plant processing solubles, and
solid plant co-products;
wherein the substrate is lumpy and has a semi-liquid or pasty texture.

2. The substrate of claim 1, wherein the plant processing solubles comprise starch production derivatives, protein production derivatives, ethanol production derivatives, or palm oil production derivatives.

3. The substrate of claim 2, wherein the plant processing solubles comprise palm oil production derivatives obtained from palm oil mill effluents (POME).

4. The substrate of claim 2, said wherein the solid plant co-products comprise at least one co-product chosen from among the group consisting of wheat by-products, corn fibers, centrifugation cakes, and palm kernel cakes.

5. The substrate of claim 4, wherein the substrate has a moisture content of between 65% and 80%.

6. The substrate of claim 5, wherein the substrate comprises between 20% and 35% dry matter.

7. A method of forming an insect larvae rearing substrate in lumpy form and with a semi-liquid or pasty texture, comprising: mixing plant processing solubles with solid plant co-products.

8. A method for rearing insect larvae, comprising:
providing an insect larvae rearing substrate including plant processing solubles solid plant co-products, the substrate being lumpy and having a semi-liquid or pasty texture;
depositing the insect larvae at a young larvae stage on the substrate;
incubating the larvae for 1 to 60 days at a temperature between 25° C. and 45° C.; and
recovering the larvae by separating the larvae from residues of the substrate and droppings.

9. The method of claim 8, wherein the substrate is not renewed after the depositing of the insect larvae and before recovering the larvae.

10. The method of claim 8, wherein the insect larva is a larva of Hermetia illucens.

11. A method of using solubles resulting from plant processing methods, comprising mixing the solubles with solid plant co-products to form an insect larvae rearing substrate.

12. The substrate of claim 1, wherein the solid plant co-products comprise at least one co-product are chosen from among the group consisting of wheat by-products, corn fibers, centrifugation cakes, and palm kernel cakes.

13. The substrate of claim 1, wherein the substrate has a moisture content of between 65% and 80%.

14. The substrate of claim 1, wherein the substrate comprises between 20% and 35% dry matter.

15. The substrate of claim 14, wherein the dry matter comprises at least one substance chosen from among the group consisting of proteins, lipids, and carbohydrates.

16. The substrate of claim 15, wherein the dry matter comprises between 8% and 30% proteins.

17. The substrate of claim 15, wherein the dry matter comprises between 3% and 16% lipids.

18. The substrate of claim 15, wherein the dry matter comprises between 0% and 70% carbohydrates.

19. The substrate of claim 1, wherein the solid plant co-products are compacted.

20. The substrate of claim 1, wherein the solid plant co-products are not compacted.
